(19) United States
(12) Patent Application Publication
(10) Pub. No.: US 2023/0053967 A1
(43) Pub. Date: Feb. 23, 2023

(54) GROUP UPDATING METHOD, MESSAGE SENDING METHOD, AND APPARATUSES

(71) Applicant: BOE Technology Group Co., Ltd., Beijing (CN)

(72) Inventors: Qian ZHANG, Beijing (CN); Junjie ZHAO, Beijing (CN); Jing SU, Beijing (CN); Yanqiu ZHAO, Beijing (CN)

(21) Appl. No.: 17/791,957

(22) PCT Filed: Jan. 15, 2021
(86) PCT No.: PCT/CN2021/072130

§ 371 Date: Jul. 11, 2022

(30) Foreign Application Priority Data
Jan. 17, 2020 (CN) 202010054612.4

(51) Int. Cl. H04L 12/18; H04L 67/52

(52) U.S. Cl. CPC H04L 12/185; H04L 67/52

(57) ABSTRACT

The present disclosure provides a method and an apparatus for group update, and a method and an apparatus for sending a message. The method for group update includes: obtaining a location group for a target area; obtaining dynamic update period of the location group; at each time point determined according to the dynamic update period, obtaining a target location of a target group object in the location group, and querying whether a business object not belonging to the location group exists within the target area; and updating the target group object in the location group according to the obtained target location and a query result. The method and the apparatus for group update and the method and the apparatus for sending a message provided by the present disclosure may implement dynamic update of the group object, and may reduce workloads and costs of group maintenance.

### CROSS-REFERENCE TO RELATED APPLICATION

This application claims priority to Chinese Patent Application No. 202010054612.4 on Jan. 17, 2020, which is incorporated herein by reference in its entirety.

### TECHNICAL FIELD

The present disclosure relates to the field of dynamic group processing technologies, and more particularly, to a method and an apparatus for group update, and a method and an apparatus for sending a message.

### BACKGROUND

As a combination of a certain type of things having the same features, a group may exist in many ways, such as design software, chat software, social networking sites, and so on. A certain theme and related organization rules may be set for each group.

Currently, established groups generally are static groups, and users need to establish these groups based on static member lists. When adding group members, the users need to add them manually. When a group is established within a certain area, the users need to manually update this group, and this group may not be dynamically updated based on locations of the group members. However, this manual mode may cause delay of group update, and may also increase workloads and costs of group maintenance.

### SUMMARY

The present disclosure provides a method and an apparatus for group update, to at least partially solve problems in the existing technologies.

According to a first aspect, the present disclosure provides a method for group update. The method for group update includes: obtaining a location group for a target area; obtaining dynamic update period of the location group; at each time point determined according to the dynamic update period, obtaining a target location of a target group object in the location group, and querying whether a business object not belonging to the location group exists within the target area; and updating the target group object in the location group according to the obtained target location and a query result.

Optionally, the updating the target group object in the location group according to the obtained target location and a query result includes: eliminating the target group object from the location group when the target location is outside the target area.

Optionally, the updating the target group object in the location group according to the obtained target location and a query result includes: adding the business object into the location group when the business object not belonging to the location group exists within the target area.

Optionally, the obtaining a location group for a target area includes: receiving a first group resource creation request; obtaining a group attribute according to the first group resource creation request; and creating a group according to the group attribute to obtain the location group for the target area.

Optionally, the obtaining a location group for a target area includes: receiving a second group resource creation request; creating an initial group according to the second group resource creation request; receiving a group update request; and updating an attribute of the initial group according to the group update request to obtain the location group for the target area.

Optionally, the group attribute includes at least one of a dynamic update period, an update duration, a target area, a location-related attribute, a dynamic update attribute, and a dynamic update notification attribute.

Optionally, the method further includes: obtaining update duration of the location group; and stopping update of the target group object in the location group when a duration from a time point when the location group is obtained to a current time point is greater than or equal to the update duration.

Optionally, the method further includes: obtaining the dynamic update notification attribute of the location group; and when determining to send a message notification to at least one of the target group object and the business object according to the dynamic update notification attribute, sending the message notification to at least one of the target group object and the business object.

According to a second aspect, the present disclosure provides a method for sending a message. The method includes: obtaining event notification decision criteria of a subscribed resource, and determining a target attribute to be monitored according to the event notification decision criteria; obtaining a changed attribute value of the target attribute when an attribute value of the target attribute is changed; constructing a differential notification message according to the changed attribute value when a notification manner is a differential notification manner; and sending the differential notification message.

Optionally, the method further includes: before obtaining the event notification decision criteria of the subscribed resource, receiving a subscription request sent by a subscriber corresponding to the subscribed resource; and creating or updating an operational attribute of the subscribed resource according to the subscription request.

Optionally, the operational attribute includes any one of the event notification decision criteria, a notification content type, and a notification manner type, wherein the notification manner type includes any one of the differential notification manner and a conventional notification manner.

Optionally, the method further includes: obtaining the notification content type and the notification manner type of the subscribed resource; and determining whether the notification manner is the differential notification manner according to the notification content type and the notification manner type.

Optionally, the determining whether the notification manner is the differential notification manner according to the notification content type and the notification manner type includes: checking the notification content type; determining the notification manner as the differential notification manner when the notification content type is a differential notification content; checking the notification manner type when the notification content type is a non-differential notification content; and determining the notification manner as the differential notification manner when the notification manner type is the differential notification manner.

Optionally, the determining whether the notification manner is the differential notification manner according to the notification content type and the notification manner type further includes:

constructing a conventional notification message according to the changed attribute value when the notification manner type is the conventional notification manner.

Optionally, the constructing a differential notification message according to the changed attribute value includes: when the changed attribute value only includes an incremental attribute value, including, in the differential notification message, an incremental identification parameter characterizing the incremental attribute value; when the changed attribute value only includes a decremental attribute value, including, in the differential notification message, a decremental identification parameter characterizing the decremental attribute value; and when the changed attribute value includes both an incremental attribute value and a decremental attribute value, including, in the differential notification message, an incremental identification parameter characterizing the incremental attribute value and a decremental identification parameter characterizing the decremental attribute value.

Optionally, the differential notification message includes an incremental attribute value, a decremental attribute value, an incremental identification parameter characterizing the incremental attribute value, and a decremental identification parameter characterizing the decremental attribute value.

According to a third aspect, the present disclosure provides an apparatus for group update. The apparatus includes: a location group obtaining module, configured to obtain a location group for a target area; a dynamic update period obtaining module, configured to obtain dynamic update period of the location group; a location object obtaining module, configured to obtain, at each time point determined according to the dynamic update period, a target location of a target group object in the location group, and to query whether a business object not belonging to the location group exists within the target area; and a group object updating module, configured to update the target group object in the location group according to the obtained target location and a query result.

According to a fourth aspect, the present disclosure provides an apparatus for sending a message. The apparatus includes: a target attribute determining module, configured to obtain event notification decision criteria of a subscribed resource, and determine a target attribute to be monitored according to the event notification decision criteria; an attribute value obtaining module, configured to obtain a changed attribute value of the target attribute when an attribute value of the target attribute is changed; a differential notification message constructing module, configured to construct a differential notification message according to the changed attribute value when a notification manner is a differential notification manner; and a differential notification message sending module, configured to send the differential notification message.

According to a fifth aspect, the present disclosure discloses an electronic device. The electronic device includes: a memory, storing a computer program; and a processor, configured to execute the computer program to implement the method for group update or the method for sending a message.

According to a sixth aspect, the present disclosure discloses a computer-readable storage medium, storing computer instructions. The computer instructions are executable by a processor of an electronic device, whereby the electronic device is configured to perform the method for group update or the method for sending a message.

Compared with the existing technologies, the present disclosure includes following advantages.

In some embodiments of the present disclosure, a target location of a target group object in a location group is obtained, it is queried whether a business object not belonging to the location group exists within the target area, and the target group object in the location group is updated according to the obtained target location and a query result. In this way, it is implemented dynamic real-time update of the group based on the location of the object within the target area, the problem of group update delay is avoided, workload of group maintenance is reduced, and maintenance costs are reduced.

### BRIEF DESCRIPTION OF THE DRAWINGS

FIG. 1 illustrates a flowchart of steps of a method for group update according to Embodiment I of the present disclosure;

FIG. 2 illustrates a schematic diagram of creating a location group according to an embodiment of the present disclosure;

FIG. 3 illustrates a schematic diagram of creating an update notification for a group according to an embodiment of the present disclosure;

FIG. 4 illustrates a flowchart of steps of a method for sending a message according to Embodiment II of the present disclosure;

FIG. 5 illustrates a schematic diagram of a differential notification message according to an embodiment of the present disclosure;

FIG. 6 illustrates a schematic structural diagram of an apparatus for group update according to Embodiment III of the present disclosure; and

FIG. 7 illustrates a schematic structural diagram of an apparatus for sending a message according to Embodiment IV of the present disclosure.

### DETAILED DESCRIPTION OF THE EMBODIMENTS

To make the foregoing objectives, features, and advantages of the present disclosure more apparent and lucid, the present disclosure is further described in detail below with reference to the accompanying drawings and specific implementations.

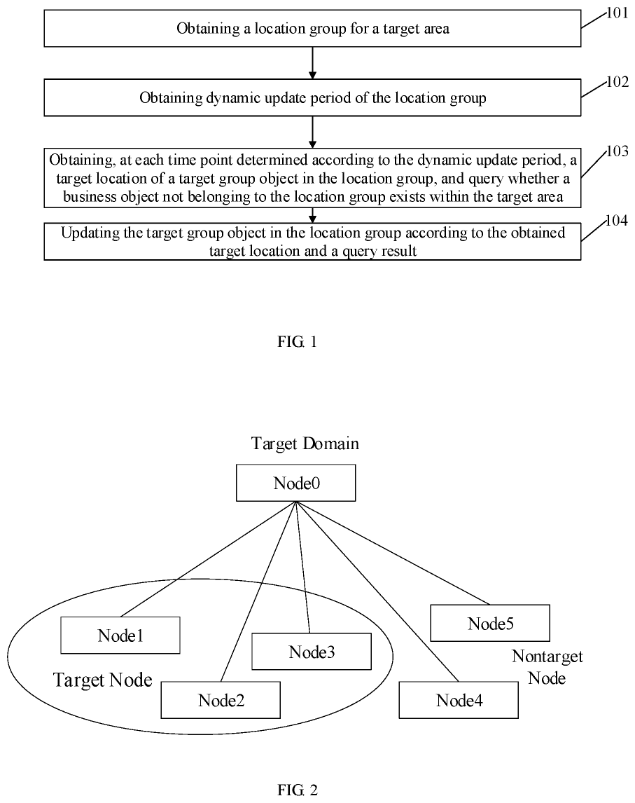

With reference to FIG. 1, a flowchart of steps of a method for group update according to Embodiment I of the present disclosure is illustrated. The method for group update may specifically include following steps.

Step 101: obtaining a location group for a target area.

In this embodiment of the present disclosure, the target area refers to an area where location groups within its scope need to be dynamically updated, such as “xx district of xx city”, or “xx road of xx district of xx city”, etc. Specifically, the target area may be determined according to business requirements, which is not limited in this embodiment of the present disclosure.

The location group refers to a pre-acquired group that needs to be dynamically updated for the target area, and the location group contains an object within the target area. According to this embodiment, the location group may be created according to a received group resource creation request. When creating the location group, an object to be added may be obtained from the target area, and the object to be added may be added to the location group to obtain the location-related location group. According to this embodiment, the location group may also be obtained based on an update method by means of an initial group created in advance.

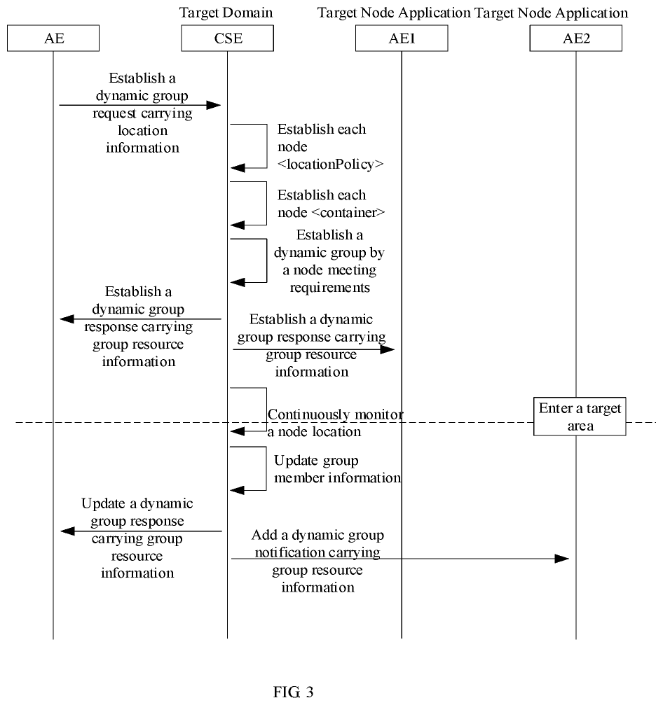

FIG. 2 illustrates a schematic diagram of creating a location group according to an embodiment of the present disclosure, and FIG. 3 illustrates a schematic diagram of creating an update notification for a group according to an embodiment of the present disclosure. A process of creating the location group is described in detail below with reference to FIG. 2 and FIG. 3 and following specific implementations.

In a specific implementation of the present disclosure, the Step 101 may include following substeps.

Substep A1.1: receiving a group resource creation request (first group resource creation request).

The group resource creation request refers to a request for creating a group. As shown in FIG. 3, the group resource creation request may be sent from an application entity (AE) to a common service entity (CSE).

The group resource creation request may be a group resource creation request that does not contain location function description information of the target area. That is, the group resource creation request may be configured for creating a location-independent group. Optionally, the group resource creation request may also be configured for creating a location-related group, but the location is different from the target area.

The group resource creation request may also be a group resource creation request containing the location function description information of the target area. As shown in FIG. 3, the AE may carry the location function description information (i.e., the target area) in the group resource creation request. When creating a location-related location group for the target area, the group resource creation request carrying the location function description information is sent to the CSE. The generated group resource creation request may also include a location-related attribute (locationRelated), and this attribute value represents a fact whether this group of resources is location-related. When this attribute value is TRUE, it means that a group to be created is location-related. When this attribute value is FALSE, it means that the group to be created is not location-related. If the attribute value is not provided in the group resource creation request, the group to be created is not location-related by default. If the group to be created is a location-related group, the group resource creation request should include the location function description information (i.e., the target area), namely locationTargetArea. This attribute value represents geographic information of the corresponding target area. This attribute value is a required attribute value when the locationRelated attribute value is TRUE.

The substep A1.2 is performed after the group resource creation request is received.

Substep A1.2: obtaining an group attribute according to the group resource creation request.

According to this embodiment, the group attribute includes at least one of dynamic update period (locationUpdatePeriod), update duration (dynamicUpdateDuration), a target area (locationTargetArea), a location-related attribute (locationRelated), a dynamic update attribute (dynamicUpdate), and a dynamic update notification attribute (dynamicUpdateNotification).

The substep A1.3 is performed after the group attribute is obtained.

Substep A1.3: creating a group according to the group attribute to obtain the location group for the target area. Specifically, an object to be added may be obtained, wherein the object to be added is an object positioned within the scope of the target area determined by the attribute locationTargetArea. The object is added to the created location group, and a value of each attribute assigned in the group resource creation request is added into the location group. For example, as shown in FIG. 2, nodes (Node1 to Node5) belong to the same target domain, such as a domain under the control of a node Node0. The group established in this way may adapt to intra-area scenes. A plurality of group objects may be obtained from the target area. Nodes that meet requirements may be determined as the group object. Still as shown in FIG. 2, the nodes Node1, Node2 and Node3 belong to the same target area, and thus may be added into the same location group for the target area. The nodes Node4 and Node5 do not belong to the above target area, and thus may not be added into the location group when the location group is created.

In another implementation, the Step 101 may include following substeps.

Substep A2.1: receiving a group resource creation request (second group resource creation request).

The second group resource creation request does not include the group attribute. That is, the second group resource creation request does not include any one of dynamic update period (locationUpdatePeriod), update duration (dynamicUpdateDuration), a target area (locationTargetArea), a location-related attribute (locationRelated), a dynamic update attribute (dynamicUpdate), and a dynamic update notification attribute (dynamicUpdateNotification). An initial group may be created according to the second group resource creation request.

Substep A2.2: creating an initial group according to the second group resource creation request.

The initial group may be an ordinary group. That is, the initial group may be a location-independent group. A group object may be added into the created initial group. That is, the created initial group includes a group member. The group object in the initial group may have an object attribute different from the aforementioned group attribute. The created initial group may also be an empty group. That is, no group object is added into the initial group. In addition, the initial group may also be a pre-existing group, i.e., a group created at a certain preceding moment, which is not limited in the present disclosure.

Substep A2.3: receiving a group update request.

The group update request may be sent from the AE to the CSE. The group update request includes the group attribute to be updated. For example, the group attribute may include at least one of dynamic update period (locationUpdatePeriod), update duration (dynamicUpdateDuration), a target area (locationTargetArea), a location-related attribute (locationRelated), a dynamic update attribute (dynamicUpdate), and a dynamic update notification attribute (dynamicUpdateNotification).

Substep A2.4: updating an attribute of the initial group according to the group update request to obtain the location group for the target area.

In this embodiment, updating an attribute value of the attribute of the initial group may have two meanings.

1. Update of the Original Attribute Value

For example, if the original attribute value of the attribute dynamicUpdate-Notification is FALSE, the original attribute value FALSE of the attribute dynamicUpdate-Notification may be updated to TRUE by updating the original attribute value.

2. Update of the Attribute Value of an Attribute that does not Exist

For example, if the created initial group does not contain the attribute dynamicUpdate, when updating the initial group, the attribute value (null) of the undefined attribute dynamicUpdate may be updated to the attribute value TRUE.

After the location group is created or updated, and after the group object is determined, a response to the group resource creation request may be made. As shown in FIG. 3, a response that satisfies the establishment of a dynamic group may be respectively returned to the AE sending the group resource creation request and a target node application (for example, AE1) included in the location group, wherein the response carries group resource information.

The specific meanings of the dynamic update period (locationUpdatePeriod), update duration (dynamicUpdateDuration), the target area (locationTargetArea), the location-related attribute (locationRelated), the dynamic update attribute (dynamicUpdate), and the dynamic update notification attribute (dynamicUpdateNotification) included in the group attribute are as shown in the table 1.

TABLE 1

| Attributes | Multi- | | | <groupAnnc> |
|---|---|---|---|---|
| of <group> | plicity | RW/RO/WO | Description | Attributes |
| locationUpdatePeriod | 0 . . . 1 | WO | The attribute value refers to | OA |
| | | | location information update interval | |
| locationRelated | 0 . . . 1 | RW | The attribute value represents a fact | OA |
| | | | whether this group of resources are | |
| | | | location-related | |
| | | | TRUE: this group is location-related | |
| | | | FALSE: this group is not location- | |
| | | | related | |
| | | | If the attribute value is not | |
| | | | provided, the group is not location- | |
| | | | related by default | |
| locationTargetArea | 0 . . . 1 | RW | The attribute value represents geographic | OA |
| | | | information of the corresponding target area | |
| | | | This attribute value is a required attribute | |
| | | | value when the locationRelated attribute | |
| | | | value is TRUE. | |
| dynamicUpdate | 0 . . . 1 | RW | The attribute value represents a fact | OA |
| | | | whether this group of resources should | |
| | | | be dynamically updated on the Hosting CSE. | |
| | | | TRUE: After the group is established, | |
| | | | this group needs to be continuously | |
| | | | updated dynamically | |
| | | | FALSE: After the group is established, | |
| | | | this group does not need to be continuously | |
| | | | updated dynamically | |
| dynamicUpdateDuration | 0 . . . 1 | RW | The attribute value represents the duration | OA |
| | | | of the dynamic update of this group of | |
| | | | resources on the Hosting CSE. This attribute | |
| | | | value is valid only when dynamicUpdate is | |
| | | | TRUE | |
| dynamicUpdateNotification | 0 . . . 1 | RW | Whether the dynamically changed group members | OA |
| | | | receive corresponding notifications | |
| | | | TRUE: Newly acceded members or newly departed | |
| | | | members receive corresponding notifications | |
| | | | FALSE: Newly acceded members or newly departed | |
| | | | members do not receive the corresponding | |
| | | | notifications | |

In the present disclosure, by updating at least one of the above-mentioned six group attributes, the initial group may be updated to the location-related location group for the target area.

According to this embodiment, it may also be determined when to stop the dynamic update operation of the location group according to the update duration of the location group, which is described in detail below in combination with the following specific implementations.

In a specific implementation of the present disclosure, the method for group update may further include following steps.

Step B1: obtaining the update duration corresponding to the location group.

In this embodiment of the present disclosure, the update duration refers to a duration of the dynamic update of the location group after the location group is obtained, i.e., after the location group is successfully created. For example, if an attribute value dynamicUpdateDuration is set for the location group, this attribute value represents the duration of the dynamic update of this group of resources on the target area. This attribute value is valid only when dynamicUpdate is TRUE.

During the creation of the location group, the duration of the dynamic update of the location group may be set, such as three days, or eight days, etc. Specifically, the value of the update duration may be determined according to business requirements, which is not limited in this embodiment of the present disclosure.

According to this embodiment, the update duration also may be an update duration set for updating the initial group as the location group, or may be an update duration set when the initial group is created. Specifically, the update duration may be determined according to business requirements, which is not limited in this embodiment of the present disclosure.

After the initial group is updated to the location group, the update duration corresponding to the location group may be obtained.

Step B2 is performed after the update duration corresponding to the location group is obtained.

Step B2: stopping the dynamic update operation of the target group object in the location group when a duration from a time point when the location group is obtained to a current time point is greater than or equal to the update duration.

Performing the update operation of the group object in the location group is continued when the duration from a time point when the location group is created to the current time point is less than the update duration. According to this embodiment, the update operation includes an operation of increasing or decreasing the group object based on the location.

When the duration from the time point when the location group is obtained to the current time point is greater than or equal to the update duration, it is stopped the dynamic update operation of the group object in the location group. That is, when the dynamic update group is converted into the ordinary group, a group administrator needs to manually delete the group object from the group or add the group object into the group when necessary subsequently. For example, the update duration may be dynamicUpdateDuration, and the Hosting CSE may decide whether to update the dynamic group member according to the attribute value of the dynamicUpdateDuration.

1. When the interval between the current time and the group creation time is less than the attribute value of the dynamicUpdateDuration, the dynamic group member is updated.

2. When the interval between the current time and the group creation time is greater than the attribute value of the dynamicUpdateDuration, the dynamic group member is not updated any more.

It is to be understood that the above examples are merely examples enumerated for better understanding the technical solutions of the embodiments of the present disclosure, and are not intended to serve as the only limitation on the embodiments of the present disclosure.

In some embodiments of the present disclosure, by setting the update duration, it may be reduced the resources consumed for continuously obtaining the location of the group object and/or continuously obtaining the business object, in the target area, that may be added into the location group.

Next, in Step 102, the dynamic update period corresponding to the location group is obtained.

The dynamic update period refers to time when the location group is dynamically updated.

In some examples, one or more time points are determined according to the dynamic update period, such as 12:00, 12:30, 13:00, 13:30, and so on.

In some examples, timekeeping of the dynamic update period may be started after the location group is obtained. The target group object is added into the location group at a plurality of time points every set time intervals from, for example, 12:00, and obtaining the location of the target group object is performed once every 20 min, i.e., 12:20, 12:40, 13:00, etc.

It is to be understood that the above examples are merely examples enumerated for better understanding the technical solutions of the embodiments of the present disclosure, and are not intended to serve as the only limitation on the embodiments of the present disclosure.

According to this embodiment, the update duration may be an update duration set for updating the initial group as the location group, or may be an initial dynamic update duration set when the initial group is created. Specifically, the dynamic update period may be determined according to business requirements, which is not limited in this embodiment of the present disclosure.

In this embodiment of the present disclosure, a group update attribute of the location group may also be set, which is described in detail in conjunction with the following specific implementations.

In a specific implementation of the present disclosure, the Step 102 may include following substeps.

Substep C1: obtaining the dynamic update attribute of the location group.

In some embodiments of the present disclosure, the dynamic update attribute of the group refers to, for example, dynamicUpdate.

After the dynamic update period is obtained, the dynamic update attribute of the location group may be obtained, and then the Substep C2 is performed.

Substep C2: the dynamic update period is obtained when the dynamic update attribute is TRUE.

After the dynamic update attribute of the location group is obtained, it may be determined, according to the dynamic update attribute, whether to dynamically update the group resource. For example, the dynamic update period is obtained when dynamicUpdate=TRUE. No subsequent operation exists when dynamicUpdate=FALSE.

Next, in Step 103, at each time point determined according to the dynamic update period, a target location of a target group object in the location group is obtained, and it is queried whether a business object not belonging to the location group exists within the target area.

The target group object refers to an object that has been added to the location-related location group. The location of the target group object may change. The target group object may be any one of a user and a movable entity, etc., and may be determined according to business requirements.

The target location refers to a location of the target group object at a time point when the location is obtained.

The business object refers to an object, positioned within the target area, that has the same type as the group object added into the location group, and the business object has not yet been added into the location group.

At the time point when the location is obtained, the target location of the target group object in the location group may be obtained, and it is queried whether the business object not belonging to the location group exists within the target area.

In some examples, the target location may be obtained by means of satellite positioning. For example, a navigation device such as Global Positioning System (GPS) carried on the target group object is in an on state. Further, real-time positioning of a mobile terminal may be implemented to obtain the target location of the target group object at the time point when the location is obtained.

In some examples, the target location may be a location sent from the target group object to the CSE. For example, a message may be sent to the target group object at a certain moment before the time point when the location is obtained, to implement location sharing between the target group objects in the group. After receiving this message, the target group object may share the location, as the target location, with the CSE.

Of course, the present disclosure is not limited thereto. In a specific implementation, those skilled in the art may obtain, using other methods, the target location of the target group object at the time point when the location is obtained. Specifically, the methods for obtaining the target location may be determined according to business requirements, which are not limited in this embodiment of the present disclosure.

As for methods for querying the business object, real-time monitoring of the target area may be employed to monitor whether there exists the business object within the target area. This embodiment of the present disclosure is not limited thereto. In a specific implementation, other methods may be employed to query whether there exists the business object within the target area, which may be determined according to business requirements, and is not limited by this embodiment of the present disclosure.

Next, in Step 104, the target group object in the location group is updated according to the obtained target location and a query result. According to this embodiment, it may be determined, according to the obtained target location, whether the target group object needs to be deleted from the location group. According to this embodiment, it may be determined, according to the query result, whether a new target group object needs to be added into the location group.

In a specific implementation of the present disclosure, the Step 104 may further include at least one of Step 104.1 and Step 104.2 as below.

Step 104.1: eliminating the target group object from the location group when the target location is outside the target area.

Step 104.2: adding the business object into the location group when the business object not belonging to the location group exists within the target area.

According to this embodiment, after the target location of the target group object is obtained, it may be determined whether the target location is within the target area. The target group object is not processed when the target location is within the target area.

According to this embodiment, when it is determined that the target group object is outside the target area, the target group object may be eliminated from the location group. The business object may be added into the location group when the business object not belonging to the location group exists within the target area. Specifically, this may be classified into the following four cases.

In the first case, the target location is outside the target area, and the business object exists within the target area.

In this case, the target group object may be eliminated from the location group, and the business object may be added into the location group.

In the second case, the target location is within the target area, and the business object exists within the target area.

In this case, the target group object is not processed, and the business object is added into the location group.

In the third case, the target location is outside the target area, and no business object exists within the target area.

In this case, the target group object may be eliminated from the location group, and the business object is not processed.

In the fourth case, the target location is within the target area, and no business object exists within the target area.

In this case, neither the target group object nor the business object is processed.

According to this embodiment of the present disclosure, dynamic update of the group member may be implemented, such that the workload of manually adding or eliminating the group member is reduced for the group administrator.

After the target group object is eliminated from the location group and/or the business object is added into the location group, it may be determined, according to a changed notification attribute corresponding to the location group, whether to send a notification message to the target group object and/or the business object, which may be specifically described in detail in conjunction with the following specific implementations.

In a specific implementation of the present disclosure, the method may further include following steps.

Step D1: obtaining a first changed notification attribute preset (for example, set by the AE) corresponding to the location group.

In this embodiment of the present disclosure, a changed notification attribute such as dynamicUpdateNotification is set for the location group in advance, and it may be decided, according to the dynamicUpdateNotification, whether to send a corresponding notification to a changed member.

The first changed notification attribute refers to sending a corresponding notification to a changed group object. For example, if the dynamicUpdateNotification=TRUE, the notification is sent.

After the target group object is eliminated from the location group and/or the business object is added into the location group, the preset first changed notification attribute corresponding to the location group may be obtained.

Step D2: generating a first notification message of the target object and/or a second notification message of the business object when it is determined, based on the first changed notification attribute, that the message notification needs to be sent.

Step D3: sending the first notification message to the target group object, and/or sending the second notification message to the business object.

The first notification message refers to a notification message generated to be sent to the target group object after the target group object is eliminated from the location group. The first notification message may be configured for notifying that the target group object has been eliminated from the location group.

The second notification message refers to a notification message generated to be sent to the business object after the business object is added into the location group. The second notification message may be configured for notifying that the business object has been added into the location group.

The first notification message of the target object and/or the second notification message of the business object may be generated when it is determined, based on the first changed notification attribute, that a message notification needs to be sent. For example, when A enters the target area, the Hosting CSE incorporates A into an attribute value memberIDs. When the dynamicUpdateNotification=TRUE, a notification is sent to A, wherein the notification contains group information. For another example, when C departs from the target area, the Hosting CSE eliminates C from the attribute value memberIDs. When the dynamicUpdateNotification=TRUE, a notification is sent to C, wherein the notification contains group information.

In another specific implementation of the present disclosure, the method may further include following steps.

Step E1: obtaining a second changed notification attribute corresponding to the preset location group.

Step E2: canceling sending the notification message to the target object and/or the business object when it is determined, based on the second changed notification attribute, that there is no need to send the message notification.

In this embodiment of the present disclosure, the second changed notification attribute refers to an attribute of not sending the notification message to a changed group member. For example, if the dynamicUpdateNotification=FALSE, no notification is sent.

When it is determined, according to the second changed notification attribute, that there is no need to send the message notification, it is canceled to send the notification message to the target group object and/or the business object. For example, B departs from the target area, and the Hosting CSE eliminates B from the attribute value memberIDs. When the dynamicUpdateNotification=FALSE, no notification is sent to B. For another example, D enters the target area, the Hosting CSE incorporates D into the attribute value memberIDs. When the dynamicUpdateNotification=TRUE, no notification is sent to D.

It is easy to understand that it may be also determined, according to the first changed notification attribute and the second changed notification attribute, whether to send a notification response to the AE creating the group. As shown in FIG. 3, after a target node application AE2 enters the target area and is added into the location group, the CSE sends an update dynamic group response to the AE, wherein the update dynamic group response carries group resource information for notifying the AE of update information of the target group object in the location group.

In some embodiments of the present disclosure, the target location of the target group object in the location group is obtained, it is queried whether a business object not belonging to the location group exists within the target area, and the target group object in the location group is updated according to the obtained target location and a query result. In this way, it is implemented dynamic real-time update of the group based on the location of the object within the target area, the problem of group update delay is avoided, workload of group maintenance is reduced, and maintenance costs are reduced.

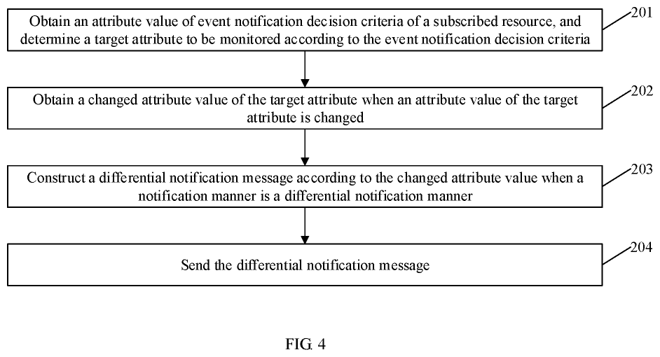

With reference to FIG. 4, a flowchart of steps of a method for sending a message according to Embodiment II of the present disclosure is illustrated, and the method for sending a message may specifically include following steps.

Step 201: obtaining event notification decision criteria of a subscribed resource, and determining a target attribute to be monitored according to the event notification decision criteria.

In this embodiment of the present disclosure, the subscribed resource may be a resource subscribed by the subscriber in advance.

The target attribute refers to an attribute, in the subscribed resource, that is subscribed by the subscriber, needs to be monitored, and may trigger generation of a matched event.

For example, in the example as shown in FIG. 3, attribute information about the application entities AE1 and AE2 is stored in the CSE. As the subscriber, the application entity AE may subscribe, from the CSE, for at least a part of the attribute information about the application entities AE1 and AE2, i.e., the subscribed resource. Further, the AE may designate the attribute (i.e., the target attribute) to be monitored in the subscribed resource, that may trigger generation of the matched event. The following method for sending a message may be employed when the CSE sends a notification message to at least one of the AE1, the AE2, and the AE.

In the process of creating the target attribute, an event notification decision criteria (eventNotificationCriteria) may be set for each attribute in advance. The event notification decision criterion indicates a criterion of whether to monitor the attribute.

In the present disclosure, when it is determined whether the attributes in the subscribed resource needs to be monitored, each attribute (eventNotificationCriteria/attribute) in the subscribed resource may be checked to obtain a value of each attribute corresponding to the event notification decision criteria.

It is to be understood that if a certain attribute is not set as eventNotificationCriteria, this attribute may be processed according to a default strategy. For example, the attribute is not monitored, and the change of the attribute value of this attribute does not trigger the generation of the matched event. This case is not considered in the present disclosure.

The settings of an operational attribute corresponding to the target attribute may be performed after the subscription request sent by the subscriber is received. Specifically, after the subscription request for the target attribute sent by the subscriber is received, the event notification decision criteria (eventNotificationCriteria), a notification content type (notificationContentType) and a notification manner type corresponding to the target attribute may be created or updated according to the subscription request. The notification manner type may include any one of a differential notification (diffNotification) and a conventional notification.

The above creation or update includes the following two cases.

1. Creation. When at least one of the operational attributes eventNotificationCriteria, notificationContentType and diffNotification is not defined for the target attribute, an operational attribute not defined by the target attribute may be created for the target attribute. For example, when the operational attribute diffNotification is not defined for the target attribute, after the subscription request from the subscriber is received, the attribute definition diffNotification may be determined according to the subscription request, and the diffNotification of the target attribute may be created.

2. Update. When at least one of the operational attributes eventNotificationCriteria, notificationContentType and diffNotification is defined for the target attribute, if at least one of the above three operational attributes needs to be updated, the corresponding operational attribute may be updated according to the subscription request from the subscriber. For example, when the operational attribute notificationContentType is defined for the target attribute, after the subscription request from the subscriber is received, if it is determined that the notificationContentType needs to be updated according to the subscription request, the notificationContentType of the target attribute may be updated.

After the value of each attribute corresponding to the event notification decision criteria is obtained, the target attribute to be monitored may be determined according to the value of each attribute corresponding to the event notification decision criteria. For example, if eventNotificationCriteria/attribute is set, the attribute designated by attribute is monitored and verified according to the attribute value of the attribute designated by attribute. If the verification succeeds, this is referred to as the generation of the matched event. If the eventNotificationCriteria/attribute is not set, changes in the attribute values of all the target attributes will trigger the generation of the matched event.

Next, in Step 202, a changed attribute value of the target attribute is obtained when the attribute value of the target attribute is changed.

According to this embodiment, the changed attribute value of the target attribute may be only the increased attribute value of the target attribute, or may be only the decreased attribute value of the target attribute, or may be the simultaneously increased and decreased attribute value of the target attribute, which may be determined based on actual situations, and no restriction is imposed on the embodiments of the present disclosure.

The changed attribute value of the target attribute may be obtained when the attribute value of the target attribute is changed. For example, if the target attribute is increased by an attribute value A and an attribute value B, the attribute value A and the attribute value B are determined as the changed attribute value. If the target attribute is decreased by an attribute value A and an attribute value C, the attribute value A and the attribute value C are determined as the changed attribute value. If the target attribute is increased by the attribute value A and is decreased by the attribute value D, the attribute value A and the attribute value D are determined as the changed attribute value.

It is to be understood that the above examples are merely examples enumerated for better understanding the technical solutions of the embodiments of the present disclosure, and are not intended to serve as the only limitation on the embodiments of the present disclosure.

Next, in Step 203, a differential notification message is constructed according to the changed attribute value when the notification manner is the differential notification manner.

The notification manner indicates a manner in which the notification message is sent. The notification manner may be determined according to a definition of the operational attribute in the subscription request sent from the subscriber.

The notification manner may include a differential notification manner and a conventional notification manner. The present disclosure is intended to describe the differential notification manner, and the conventional notification manner will not be described in detail.

After the target attribute is obtained, the notification manner corresponding to the target attribute may be verified and obtained, which may be specifically described in detail in conjunction with the following specific implementations.

In a specific implementation of the present disclosure, the Step 203 may include following substeps.

Substep F1: obtaining the notification content type and the notification manner type of the subscribed resource.

Substep F2: determining whether the notification manner corresponding to the target attribute is the differential notification manner according to the notification content type and the notification manner type.

In a specific implementation of the present disclosure, the Step F2 may include following substeps.

Substep F2.1: checking the notification content type.

Substep F2.2: determining the notification manner as the differential notification manner when the notification content type is a differential notification content.

Substep F2.3: checking the notification manner type when the notification content type is a non-differential notification content.

Substep F2.4: determining the notification manner as the differential notification manner when the notification manner type is the differential notification manner.

In this embodiment of the present disclosure, the notification content type refers to a content type for which the notification message is generated, i.e., notificationContentType.

In the present disclosure, the notificationContentType may include five types as below: ‘Modified Attributes’, ‘All Attributes’, ‘ResourceID’, ‘Trigger Payload’, and ‘Modified Difference’. Different types may constitute different notification contents.

‘Modified Attributes’ corresponds to only transferring changed attribute value information.

‘All Attributes’ corresponds to transferring attribute value information of resources.

‘ResourceID’ corresponds to only transferring information involved with resource ID.

‘Trigger Payload’ corresponds to transferring trigger payload information.

‘Modified Difference’ corresponds to only transferring change information of changed attribute values.

It is to be understood that the core point of the present disclosure lies in the ‘Modified Difference’, and the other four types are not described again in this embodiment of the present disclosure.

The notification manner type refers to the type of the notification message sent to the subscriber when the target attribute changes in its attribute value.

Two manners may be employed to check whether to carry out the differential notification.

1. It is checked whether the notification content type corresponding to the target attribute is ‘Modified Difference’, i.e., it is checked whether the notification type attribute of the notificationContentType is ‘Modified Difference’. The differential notification is carried out if the check result is YES.

2. The notification manner type (including the differential notification manner and the conventional notification manner) corresponding to the target attribute is checked. That is, when the notification manner type is the differential notification manner (diffNotification), the differential notification is carried out. When the notification manner type is the conventional notification manner, a conventional notification message of the changed attribute value may be constructed to carry out the conventional notification.

First, the notification content type of the target attribute may be verified, and the differential notification is carried out when the notification content type is the differential notification type.

Second, when it is checked that the notification content type of the target attribute is a non-differential notification content, the notification manner type of the target attribute is checked, and the differential notification is carried out when the notification manner type is the differential notification type.

According to this embodiment, the differential notification manner refers to a manner of sending a notification to the subscriber through the generated differential notification manner.

There are following two cases of determining the notification manner as the differential notification manner.

1. The differential notification is carried out when it is checked that the notification content type (notificationContentType) of the target attribute is ‘Modified Difference’.

2. When it is checked that the notification content type notificationContentType) of the target attribute is the non-differential notification content other than ‘Modified Difference’, if it is checked that the notification manner type of the target attribute is TRUE, i.e., if the notification manner type is the differential notification manner, the differential notification is carried out.

A differential notification message may be constructed according to the changed attribute value when the notification manner is the differential notification manner.

The differential notification message may include an incremental attribute value, a decremental attribute value, an incremental identification parameter characterizing the incremental attribute value, and a decremental identification parameter characterizing the decremental attribute value.

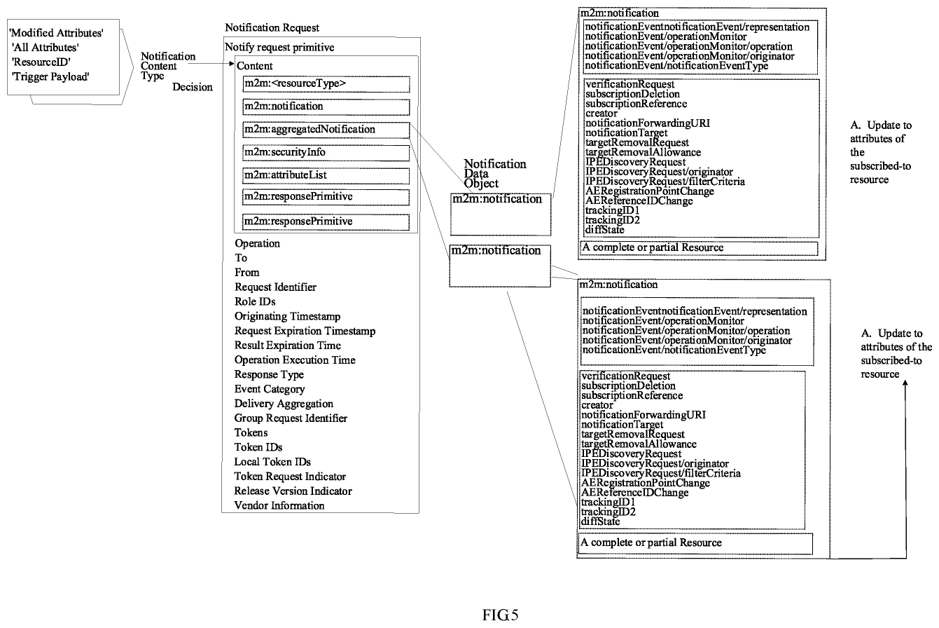

In this embodiment of the present disclosure, the differential notification message may be described in detail below with reference to FIG. 5.

As shown in FIG. 5, it may be decided which type of notification message is generate according to the notification ContentType. When the notification ContentType is a differential notification type (i.e., Modified Difference, not shown in the figure), a differential notification message may be constructed, namely m2m: notification. The generated notification message may contain an identification parameter of the attribute value. That is, the notification message contains “diffState”. Specifically, the identification parameter may be classified into an incremental identification parameter, a decremental identification parameter, and the like. After the differential notification message is generated, the differential notification message may be sent to the subscriber, and then the subscriber may update, according to the differential notification message, the attribute of the subscribed resource, i.e., Update to attributes of the subscribed-to resource as shown in FIG. 5.

The changed attribute value may include at least one of the incremental attribute value and the decremental attribute value. The corresponding differential notification message may be constructed according to the specific incremental attribute value and the decremental attribute value, which may be specifically described in detail below in conjunction with the following specific implementations.

In a specific implementation of the present disclosure, when the changed attribute value only includes the incremental attribute value, a differential notification message corresponding to increasing the incremental attribute value is constructed, wherein the differential notification message contains the incremental identification parameter characterizing the incremental attribute value.

In this embodiment of the present disclosure, when the changed attribute value only contains the incremental attribute value, the differential notification message corresponding to increasing the incremental attribute value may be constructed, wherein the differential notification message contains the incremental identification parameter characterizing the incremental attribute value. For example, diffState=ADDITIONS, the changed incremental attribute value information (such as the incremental attribute value information DE of the attribute value A) needs to transferred.

In a specific implementation of the present disclosure, when the changed attribute value only includes the decremental attribute value, a differential notification message corresponding to decreasing the decremental attribute value is constructed, wherein the differential notification message contains the decremental identification parameter characterizing the decremental attribute value.

When the changed attribute value only contains the decremental attribute value, a differential notification message corresponding to decreasing the decremental attribute value may be constructed, wherein the differential notification message contains the decremental identification parameter characterizing the decremental attribute value. For example, diffState=DECREASES, the changed decremental attribute value information (such as the decremental attribute value information AB of the attribute value A) needs to transferred.

In a specific implementation of the present disclosure, when the changed attribute value includes both an incremental attribute value and a decremental attribute value, a differential notification message for increasing the incremental attribute value and decreasing the decremental attribute value may be constructed, wherein the differential notification message includes an incremental identification parameter characterizing the incremental attribute value and a decremental identification parameter characterizing the decremental attribute value.

When the changed attribute value includes both an incremental attribute value and a decremental attribute value, a differential notification message for increasing the incremental attribute value and decreasing the decremental attribute value may be constructed, wherein the differential notification message includes an incremental identification parameter characterizing the incremental attribute value and a decremental identification parameter characterizing the decremental attribute value, for example, a group member increases F and decreases C.

Next, in Step 204, the differential notification message is sent.

According to this embodiment, the differential notification message may be sent to the subscriber corresponding to the target subscribed resource. The subscriber refers to a business party that has subscribed to an attribute value change reception notification message of the target attribute. The subscriber may be a certain user or a certain business platform. Specifically, the subscriber may be determined according to business requirements.

In addition, it is to be noted that the subscriber here is a subscriber in a broad sense, not only including the AE that subscribes, from the CSE, for resources and designates the target attribute to be monitored, but also including each group member included in the group. For example, the node AE1 in the group member may also subscribe, from the CSE, for the resource to receive the notification message.

After the differential notification message is obtained, the differential notification message may be sent to the subscriber, such that the differential notification of the message may be implemented.

The embodiments of the present disclosure may be used for uniformly managing electronic tags within a specific area. For example, in terms of subscription notification, optimization of a size of a data package may be implemented by means of differential notification. For example, for a commodity push scenario in a supermarket, the supermarket has a wide variety of commodities, and new commodities are pushed by means of subscription notification. In this scenario, it is suitable to carry out a notification by means of the differential notification. By differentially subscribing to a catalog in a smart retail server, more intuitive information about new commodities may be obtained.

According to the method for sending a message provided in this embodiment of the present disclosure, a target attribute is determined by obtaining a subscription resource event notification decision criteria, a corresponding differential notification message is constructed according to the obtained changed attribute value of the target attribute, and the differential notification message is sent to the subscriber corresponding to the target attribute. The embodiments of the present disclosure may implement a differential notification for a changed attribute value of a target attribute, such that the subscriber may learn, in time, the changed attribute value of the target attribute. In this way, perception of the subscriber may be improved.

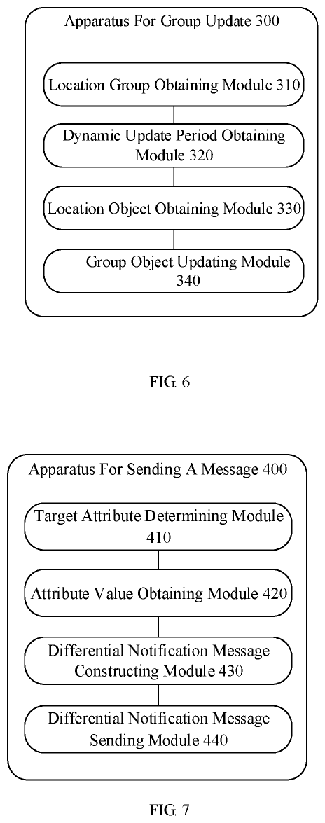

With reference to FIG. 6, a schematic structural diagram of an apparatus for group update according to Embodiment III of the present disclosure is illustrated. The apparatus 300 for group update may specifically include following modules:

a location group obtaining module 310, configured to obtain a location group for a target area;

a dynamic update period obtaining module 320, configured to obtain dynamic update period of the location group;

a location object obtaining module 330, configured to obtain, at each time point determined according to the dynamic update period, a target location of a target group object in the location group, and to query whether a business object not belonging to the location group exists within the target area; and

a group object updating module 340, configured to update the target group object in the location group according to the obtained target location and a query result.

In a specific implementation, the group object updating module 340 includes:

an object eliminating unit, configured to eliminate the target group object from the location group when the target location is outside the target area.

In a specific implementation, the group object updating module 340 also includes:

an object adding unit, configured to add the business object into the location group when the business object not belonging to the location group exists within the target area.

In a specific implementation, the location group obtaining module 310 includes:

a request receiving unit, configured to receive a first group resource creation request, or to receive a second group resource creation request and a group update request;

a group attribute obtaining unit, configured to obtain a group attribute according to the first group resource creation request and the group update request;

a location group creating unit, configured to create a group according to the group attribute to obtain the location group for the target area;

an initial group creating unit, configured to create an initial group according to the second group resource creation request; and

an initial group updating unit, configured to update an attribute of the initial group according to the group update request to obtain the location group for the target area.

In a specific implementation, the apparatus 300 for group update also includes:

an update duration obtaining module, configured to obtain update duration of the location group; and

a dynamically updating and timekeeping module, configured to calculate a duration from a time point when the location group is obtained to a current time point, and control, when this duration is greater than or equal to the update duration, the group object updating module 340 to stop update of the target group object in the location group.

In a specific implementation, the apparatus 300 for group update also includes:

a notification attribute obtaining module, configured to obtain the dynamic update notification attribute of the location group; and

a notification message sending module, configured to send, when determining to send a message notification to at least one of the target group object and the business object according to the dynamic update notification attribute, the message notification to at least one of the target group object and the business object.

In a specific implementation, the notification attribute obtaining module includes:

a first notification attribute obtaining unit, configured to obtain a first changed notification attribute corresponding to the preset location group;

a first notification message generating unit, configured to generate a first notification message of the target object and/or a second notification message of the business object when it is determined, based on the first changed notification attribute, that the message notification needs to be sent; and

a second notification attribute obtaining unit, configured to obtain a second changed notification attribute corresponding to the preset location group.

The notification message sending module may be configured to send the first notification message to the target group object, and/or send the second notification message to the business object. Furthermore, when it is determined, based on the second changed notification attribute, that there is no need to send the message notification, the notification message sending module may cancel sending the notification message to the target object and/or the business object.

The apparatus for group update provided by this embodiment of the present disclosure implements dynamic real-time update of the group based on the location of the object within the target area, avoids the problem of group update delay, reduces workload of group maintenance, and reduces maintenance costs.

With reference to FIG. 7, a schematic structural diagram of an apparatus for sending a message according to Embodiment IV of the present disclosure is illustrated. The apparatus 400 for sending a message may specifically include following modules:

a target attribute determining module 410, configured to obtain event notification decision criteria of a subscribed resource, and determine a target attribute to be monitored according to the event notification decision criteria;

an attribute value obtaining module 420, configured to obtain a changed attribute value of the target attribute when an attribute value of the target attribute is changed;

a differential notification message constructing module 430, configured to construct a differential notification message according to the changed attribute value when a notification manner is a differential notification manner; and

a differential notification message sending module 440, configured to send the differential notification message.

In a specific implementation, the apparatus 400 for sending a message also includes:

a subscription request receiving module, configured to receive a subscription request sent by a subscriber corresponding to the subscribed resource; and

an operational attribute obtaining module, configured to create or update an operational attribute of the subscribed resource according to the subscription request.

In a specific implementation, the apparatus 400 for sending a message also includes:

a notification manner determining module, configured to determine whether the notification manner is the differential notification manner according to the notification content type and the notification manner type.

In a specific implementation, the notification manner determining module includes:

a first checking unit, configured to check the notification content type;

a first differential notification manner determining unit, configured to determine the notification manner as the differential notification manner when the notification content type is a differential notification content;

a second checking unit, configured to check the notification manner type when the notification content type is a non-differential notification content; and

a second differential notification manner determining unit, configured to determine the notification manner as the differential notification manner when the notification manner type is the differential notification manner.

In a specific implementation, the apparatus 400 for sending a message also includes:

a conventional notification message constructing module, configured to construct a conventional notification message according to the changed attribute value when a notification manner type is a conventional notification manner.

In a specific implementation, the differential notification message constructing module 430 includes:

an incremental message constructing unit, configured to construct, when the changed attribute value only includes an incremental attribute value, a differential notification message corresponding to the incremental attribute value, wherein the differential notification message includes an incremental identification parameter characterizing the incremental attribute value;

a decremental message constructing unit, configured to construct, when the changed attribute value only includes a decremental attribute value, a differential notification message corresponding to the decremental attribute value, wherein the differential notification message includes a decremental identification parameter characterizing the decremental attribute value;

and

an incremental and decremental message constructing unit, configured to construct, when the changed attribute value includes both an incremental attribute value and a decremental attribute value, a differential notification message for increasing the incremental attribute value and decreasing the decremental attribute value, wherein the differential notification message includes an incremental identification parameter characterizing the incremental attribute value and a decremental identification parameter characterizing the decremental attribute value.

The apparatus for sending a message provided by this embodiment of the present disclosure may implement a differential notification for a changed attribute value of a target attribute, such that a subscriber may learn, in time, the changed attribute value of the target attribute. In this way, perception of the subscriber may be improved.

It should be explained that, for a brief description, the foregoing method embodiments are described as a combination of a series of motions. However, those skilled in the art should know that the present disclosure is not limited by sequences of the motions described. This is because some steps may be performed by using other sequences or be performed simultaneously in accordance with the present disclosure In addition, those skilled in the art should also learn that the embodiments described in the specification are preferred embodiments, and involved motions and modules are not necessary for the present disclosure

In addition, an embodiment of the present disclosure also provides an electronic device, which includes a processor and a memory. The memory stores a computer program executable by the processor. The computer program is executable by the processor, whereby the electronic device is configured to perform the method for group update or the method for sending a message.

An embodiment of the present disclosure also provides a computer-readable storage medium, storing computer instructions. The computer instructions are executable by the processor of the electronic device, whereby the electronic device is configured to perform the method for group update or the method for sending a message.

The embodiments in the specification are described in a progressive manner. Each embodiment is focused on difference from other embodiments. And cross reference is available for identical or similar parts among different embodiments.

Finally it should be explained that a relational term (such as a first or a second . . . ) is merely intended to separate one entity or operation from another entity or operation instead of requiring or hinting any practical relation or sequence exists among these entities or operations. Furthermore, terms such as “comprise”, “include” or other variants thereof are intended to cover a non-exclusive “comprise” so that a process, a method, a merchandise or a device comprising a series of elements not only includes these elements, but also includes other elements not listed explicitly, or also includes inherent elements of the process, the method, the merchandise or the device. In the case of no more restrictions, elements restricted by a sentence “include a . . . ” do not exclude the fact that additional identical elements may exist in a process, a method, a merchandise or a device of these elements.

A method for group update, a method for sending a message, an apparatus for group update, and an apparatus for sending a message provided by the present disclosure are described in detail above. Elaboration of principles and implementations of the present disclosure is made by using specific examples herein, and the description of the foregoing embodiments is merely intended to assist in understanding the method of the present disclosure and the core concept thereof. Also, those of ordinary skill in the art may change, in accordance with the concept of the present disclosure, a concrete implementation and a scope of application. In conclusion, contents of the specification shall be not interpreted as limiting the present disclosure.

1. A method for group update, comprising:
obtaining a location group for a target area;
obtaining dynamic update period of the location group;
at each time point determined according to the dynamic update period, obtaining a target location of a target group object in the location group, and querying whether a business object not belonging to the location group exists within the target area; and
updating the target group object in the location group according to the obtained target location and a query result.

2. The method according to claim 1, wherein the updating the target group object in the location group according to the obtained target location and a query result comprises:
eliminating the target group object from the location group when the target location is outside the target area.

3. The method according to claim 1 or 2, wherein the updating the target group object in the location group according to the obtained target location and a query result comprises:
adding the business object into the location group when the business object not belonging to the location group exists within the target area.

4. The method according to claim 1, wherein the obtaining a location group for a target area comprises:
receiving a first group resource creation request;
obtaining a group attribute according to the first group resource creation request; and
creating a group according to the group attribute to obtain the location group for the target area.

5. The method according to claim 1, wherein
the obtaining a location group for a target area comprises:
receiving a second group resource creation request;
creating an initial group according to the second group resource creation request;
receiving a group update request; and
updating an attribute of the initial group according to the group update request to obtain the location group for the target area.

6. The method according to claim 4, wherein the group attribute comprises at least one of a dynamic update period, an update duration, a target area, a location-related attribute, a dynamic update attribute, and a dynamic update notification attribute.

7. The method according to claim 4, further comprising:
obtaining update duration of the location group; and
stopping update of the target group object in the location group when a duration from a time point when the location group is obtained to a current time point is greater than or equal to the update duration.

8. The method according to claim 4, further comprising:
obtaining the dynamic update notification attribute of the location group; and
when determining to send a message notification to at least one of the target group object and the business object according to the dynamic update notification attribute, sending the message notification to at least one of the target group object and the business object.

9. A method for sending a message, comprising:
obtaining event notification decision criteria of a subscribed resource, and determining a target attribute to be monitored according to the event notification decision criteria;
obtaining a changed attribute value of the target attribute when an attribute value of the target attribute is changed;
constructing a differential notification message according to the changed attribute value when a notification manner is a differential notification manner; and
sending the differential notification message.

10. The method according to claim 9, wherein before obtaining the event notification decision criteria of the subscribed resource, the method further comprises:
receiving a subscription request sent by a subscriber corresponding to the subscribed resource; and
creating or updating an operational attribute of the subscribed resource according to the subscription request.

11. The method according to claim 10, wherein the operational attribute comprises any one of the event notification decision criteria, a notification content type, and a notification manner type, wherein the notification manner type comprises any one of the differential notification manner and a conventional notification manner.

12. The method according to claim 9, further comprising:
obtaining the notification content type and the notification manner type of the subscribed resource; and
determining whether the notification manner is the differential notification manner according to the notification content type and the notification manner type.

13. The method according to claim 12, wherein the determining whether the notification manner is the differential notification manner according to the notification content type and the notification manner type comprises:
checking the notification content type;
determining the notification manner as the differential notification manner when the notification content type is a differential notification content;
checking the notification manner type when the notification content type is a non-differential notification content; and
determining the notification manner as the differential notification manner when the notification manner type is the differential notification manner.

14. The method according to claim 13, wherein the determining whether the notification manner is the differential notification manner according to the notification content type and the notification manner type further comprises:
constructing a conventional notification message according to the changed attribute value when the notification manner type is the conventional notification manner.

15. The method according to claim 9, wherein the constructing a differential notification message according to the changed attribute value comprises:
when the changed attribute value only comprises an incremental attribute value, comprising, in the differential notification message, an incremental identification parameter characterizing the incremental attribute value;
when the changed attribute value only comprises a decremental attribute value, comprising, in the differential notification message, a decremental identification parameter characterizing the decremental attribute value; and
when the changed attribute value comprises both an incremental attribute value and a decremental attribute value, comprising, in the differential notification message, an incremental identification parameter characterizing the incremental attribute value and a decremental identification parameter characterizing the decremental attribute value.

16. The method according to claim 9, wherein the differential notification message comprises an incremental attribute value, a decremental attribute value, an incremental identification parameter characterizing the incremental attribute value, and a decremental identification parameter characterizing the decremental attribute value.

17. An electronic device for group update, comprising:
a memory, storing a computer program; and
a processor, configured to execute the computer program to implement the operations including:
obtaining a location group for a target area;
obtaining dynamic update period of the location group;
obtaining, at each time point determined according to the dynamic update period, a target location of a target group object in the location group, and querying whether a business object not belonging to the location group exists within the target area; and
updating the target group object in the location group according to the obtained target location and a query result.

18. An electronic device for sending a message, comprising:
a memory, storing a computer program; and
a processor, configured to execute the computer program to implement the method according to claim 9.

19. (canceled)

20. A nonvolatile computer-readable storage medium, storing computer instructions, wherein the computer instructions are executable by a processor of an electronic device, whereby the electronic device is configured to perform the method for group update according to claim 1.
